(19) United States
(12) Patent Application Publication
(10) Pub. No.: US 2023/0032011 A1
(43) Pub. Date: Feb. 2, 2023

(54) FORECAST GENERATING SYSTEM AND METHOD THEREOF

(71) Applicant: PANASONIC INTELLECTUAL PROPERTY MANAGEMENT CO., LTD., Osaka (JP)

(72) Inventors: Koji MIURA, Osaka (JP); Yukinori SASAKI, Hyogo (JP); Akira MINEGISHI, Osaka (JP); Yizhou HUANG, Singapore (SG); Debdeep PAUL, Singapore (SG); Yongning YIN, Singapore (SG); Khai JUN KEK, Singapore (SG)

(21) Appl. No.: 17/389,042

(22) Filed: Jul. 29, 2021

(51) Int. Cl. G06Q 10/04; G06N 3/08; G06K 9/62

(52) U.S. Cl. CPC G06Q 10/04; G06N 3/08; G06K 9/6202; G06K 9/6228; G06K 9/6257; G06K 9/6268

(57) ABSTRACT

A system for generating a forecast including a classifier module for receiving from a user, at least one feature and classifying the at least one feature into a plurality of priority groups based on a user preference. The system further includes an artificial intelligence (AI) forecast module in communication with the classifier module for processing the plurality of priority groups with at least one feature. The AI forecast module derive a learning from classification of the at least one feature into the plurality of priority groups; and generate the forecast based on the learning.

### FIELD OF THE INVENTION

The present disclosure, in general, relates to a system and method for generating forecast. More particularly, the invention relates to a system and method for classifying features according to user input and generate business forecast.

### BACKGROUND

As is appreciated by those familiar with the art, a lack of study in demand and supply in a particular business may prove costly to business owners in today's competitive market. The discrepancy of demand and supply may result in missing potential sales opportunities, decreased revenue, excessive operational costs, shrinking profits, and poor customer service. To maximize sales and marketing effectiveness, business owners must accurately predict future customer demand and use this information to drive their business operations from manufacturing to operations to distribution.

In the process of prediction such as, forecasting demand, sales or revenues, business owners generate the forecast in raw numbers input or otherwise provided from various users working for the business owner as employees. This process is typically completed on a periodic basis. One major drawback of this process is, the employees reviewing the forecast to derive understanding of trends and patterns in the forecast, is to understand how the current forecast differs from the previous forecast or even from more than one forecast. In other words, when multiple forecasts, differ, why do they differ, and can some corrective action be taken.

In most organizations, human data analysts perform the manual and laborious process of comparing the generated forecast for understanding the variance. Computers may be used in combination with the manual efforts, but the manual effort has conventionally been required. Some business owners may use business intelligence tools that enables them to more quickly and in automated fashion compare the two forecast snapshots. However, heretofore there are problems and/or limitations with both conventional approaches and with the tools used for these conventional approaches.

Todays' modern factories are accelerating digital transformation in the business, and its operation, by leveraging Artificial Intelligence (AI) and Big Data techniques to optimize business performance and maximize return on investment. Therefore, it is required that business tools used for generating forecast implement AI and Big Data techniques to ensure an accurate business forecast.

The Big Data has driven the development and success of advanced AI technology. However, as every technology has its own set of limitations, the traditional AI and machine learning solutions have less control of the operations and results in issues of poor interpretability and robustness. Such drawbacks lead to issues of risk around critical business decision.

The known industry techniques use predictive modelling methods which adopts machine learning and big data techniques. In these existing approaches, the use of input data is primarily subject to employed feature engineering and forecast model methods. One fundamental drawback of these methods is that business wisdom such as business logic and expert domain knowledge are not effectively utilized in traditional machine learning models. Models driving on static algorithms may be exposed to data drift issue and thus cannot ensure high forecast accuracy and robustness without business wisdom.

The problem is even more acute in situations where the number of training instances is limited, as limited sample size and domain complexity adds to the number of problems. Besides, existing approaches normally do not perform well for predictive targets with big fluctuation in nature.

There is a need for a solution that determines generation of forecast with model controllability and thus generate highly explainable and robust forecast models. It is required that to propose a solution to optionally allow user with business domain knowledge to adjust business features and tune model performance and improve model explanatory power.

The proposed solution may be implemented in creating smart factories. The solution to generate accurate forecast with model controllability and robust model is well implemented in:
(i) Manufacturing systems with hierarchical and sequential processes. Such system have critical requirement to perform both intra-process and inter-process analysis to identity and predict productivity, quality, and maintenance issues.
(ii) A robot machine system which includes one or more core motors to drive the operation of the manufacturing. Reliability and accurate operations are critical to obtain high productivity and quality. The system may use conditional sensors for monitoring the machine conditions and to provide input to prediction system for generating performance forecast.
(iii) A factory supply chain process for analyzing and predicting all supply-demand information of market and optimize production management and investment decisions.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

A system for generating a forecast including a classifier module configured to receive from a user, at least one feature. The classifier module classifies the at least one feature into a plurality of priority groups based on a user preference. The system includes an artificial intelligence (AI) forecast module in communication with the classifier module configured to process the plurality of priority groups with at least one feature for deriving a learning from classification of the at least one feature into the plurality of priority groups. The system includes generating the forecast based on the learning.

In an alternative embodiment of the invention, a method including receiving, by a classifier module, at least one feature from a user. Further, classifying, by the classifier module, the at least one feature into a plurality of priority groups based on a user preference. The method includes processing, by an artificial intelligence (AI) forecast module, the plurality of priority groups with at least one feature. Deriving, by the artificial intelligence (AI) forecast module, a learning from classification of the at least one feature into the plurality of priority groups; and generating the forecast based on the learning.

To further clarify advantages and features of the disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an environment of implementation of a system for generating a forecast, in accordance with an embodiment of the disclosure;

FIG. 2 illustrates an implementation of the system as illustrated in FIG. 1 in a computing environment, in accordance with an embodiment of the disclosure;

FIG. 3 illustrates the system graphical user interface (GUI) featuring an overview of dashboard for generating the forecast, in accordance with an embodiment of the disclosure;

FIG. 4 illustrates an example illustration of the system graphical user interface (GUI) featuring a classification of a feature for generating the forecast, in accordance with an embodiment of the disclosure;

FIG. 5 illustrates a cascaded artificial intelligence model architecture, in accordance with an embodiment of the disclosure;

FIG. 6 illustrates a hierarchical architecture intelligence model architecture, according to an embodiment of the present disclosure;

FIG. 7 illustrates an example illustration of the system graphical user interface (GUI) featuring an impact indicator value, according to an embodiment of the present disclosure;

FIG. 8 illustrates an example illustration of the system graphical user interface (GUI) featuring the impact indicator value, according to an embodiment of the present disclosure; and

FIG. 9 illustrates a flowchart of the method for generating forecast, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the disclosure will be described below in detail with reference to the accompanying drawings.

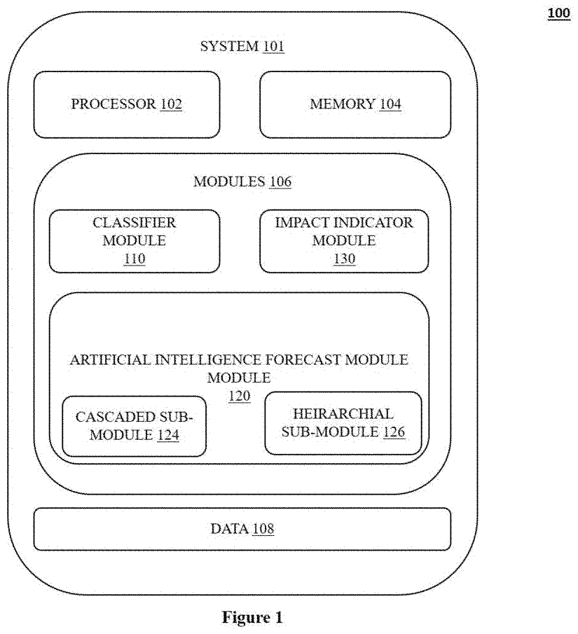

FIG. 1 illustrates an environment 100 for implementing a system 101 for generating a forecast, in accordance with an embodiment of the disclosure. The environment 100 may include the system 101 interacting with a user wirelessly or in a wired connection. The system 101 may be centrally managed or individually addressable to process a user input data and display text, graphs, visual data, animation, and video messages for generating, monitoring, prediction forecasting, and information, to targeted audiences.

The system 101 may be wirelessly connected to a remote server or a cloud server or the like for accessing various information and getting updated. For the sake of brevity, the remote server or the cloud server has not been shown in the FIG. 1.

The system 101 may include, but is not limited to, a processor 102, a memory 104, and data 108. The system further includes modules 106 which along with the memory 104 may be coupled to the processor 102.

In an embodiment the modules 106 may include a classifier module 110, an artificial intelligence module 120, a cascaded sub-module 124, a hierarchical sub-module 126, an impact indicator module 130. The classifier module 110, the artificial intelligence module 120, the cascaded sub-module 124, the hierarchical sub-module 126, an impact indicator module 130 may be in communication with each other. The data 108 serves, amongst other things, as a repository for storing data processed, received, and generated by one or more of the modules 106.

The modules 106, amongst other things, include routines, programs, objects, components, data structures, etc., which perform particular tasks or implement data types. The modules 106 may also be implemented as, signal processor(s), state machine(s), logic circuitries, and/or any other device or component that manipulate signals based on operational instructions.

Further, the modules 106 can be implemented in hardware, instructions executed by a processing unit, or by a combination thereof. The processing unit can comprise a computer, a processor, such as the processor 102, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 106 may be machine-readable instructions (software) which, when executed by a processor/processing unit, perform any of the described functionalities.

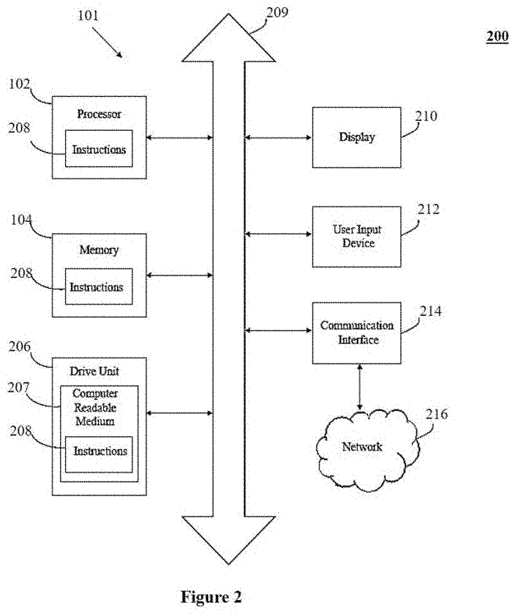

FIG. 2 illustrates an implementation of the system 101 as illustrated in FIG. 1 in a computing environment. The present figure essentially illustrates the hardware configuration of the system 101 in the form of a computer system 200. The computer system 200 can include a set of instructions that can be executed to cause the computer system 200 to perform any one or more of the systems and methods disclosed. The computer system 200 may operate as a standalone device or may be connected, e.g., using a network, to other computer systems or peripheral devices.

In a networked deployment, the computer system 200 may operate in the capacity of a server or as a client user computer in a server-client user network environment, or as a peer computer system in a peer-to-peer (or distributed) network environment. The computer system 200 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 200 is illustrated, the term “system” shall also be taken to include any collection of systems or sub-systems that individually or jointly execute a set, or multiple sets, of instructions to perform one or more computer functions.

The computer system 200 may include a processor 102 (e.g., a central processing unit (CPU), a graphics processing unit (GPU), or both. The processor 102 may be a component in a variety of systems. For example, the processor 102 may be part of a standard personal computer or a workstation. The processor 102 may be one or more general processors, digital signal processors, application specific integrated circuits, field programmable gate arrays, servers, networks, digital circuits, analog circuits, combinations thereof, or other now known or later developed devices for analyzing and processing data The processor 102 may implement a software program, such as code generated manually (i.e., programmed).

The computer system 200 may include a memory 104, such as a memory 104 that can communicate via a bus 209. The memory 104 may be a main memory, a static memory, or a dynamic memory. The memory 104 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one example, the memory 104 includes a cache or random-access memory for the processor 102. In alternative examples, the memory 104 is separate from the processor 102, such as a cache memory of a processor, the system memory, or other memory. The memory 104 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 104 is operable to store instructions executable by the processor 102. The functions, acts or tasks illustrated in the figures or described may be performed by the programmed processor 102 executing the instructions stored in the memory 104. The functions, acts or tasks are independent of the instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 200 may or may not further include a display unit 210, such as a liquid crystal display (LCD), an organic light emitting diode (OLED), a flat panel display, a solid-state display, a cathode ray tube (CRT), a projector, a printer or other now known or later developed display device for outputting determined information. The display 210 may act as an interface for the user to see the functioning of the processor 102, or specifically as an interface with the software stored in the memory 104 or in the drive unit 206.

Additionally, the computer system 200 may include an input device 212 configured to allow a user to interact with any of the components of system 200. The input device 212 may be a number pad, a keyboard, or a cursor control device, such as a mouse, or a joystick, touch screen display, remote control, or any other device operative to interact with the computer system 200.

The computer system 200 may also include a disk or optical drive unit 206. The disk drive unit 206 may include a computer-readable medium 207 in which one or more sets of instructions 208, e.g., software, or modules 106 can be embedded. Further, the instructions 208 may embody one or more of the methods or logic as described. In a particular example, the instructions 208 may reside completely, or at least partially, within the memory 104 or within the processor 102 during execution by the computer system 200. The memory 104 and the processor 102 also may include computer-readable media as discussed above.

The present invention contemplates a computer-readable medium that includes instructions 208 or receives and executes instructions 208 responsive to a propagated signal so that a device connected to a network 216 can communicate voice, video, audio, images or any other data over the network 216. Further, the instructions 208 may be transmitted or received over the network 216 via a communication port or interface 214 or using a bus 209. The communication port or interface 214 may be a part of the processor 102 or may be a separate component. The communication port 214 may be created in software or may be a physical connection in hardware. The communication port 214 may be configured to connect with a network 216, external media, the display 210, or any other components in computer system 200 or combinations thereof. The connection with the network 216 may be a physical connection, such as a wired Ethernet connection or may be established wirelessly as discussed later. Likewise, the additional connections with other components of the computer system 200 may be physical connections or may be established wirelessly. The network 216 may alternatively be directly connected to the bus 209.

The network 216 may include wired networks, wireless networks, Ethernet AVB networks, or combinations thereof. The wireless network may be a cellular telephone network, an 802.11, 802.16, 802.20, 802.1Q or WiMax network. Further, the network 216 may be a public network, such as the Internet, a private network, such as an intranet, or combinations thereof, and may utilize a variety of networking protocols now available or later developed including, but not limited to TCP/IP based networking protocols.

In an example, dedicated hardware implementations, such as application specific integrated circuits, programmable logic arrays and other hardware devices, can be constructed to implement various parts of the system 101. A detailed implementation of the system 100 will be explained in the forthcoming paragraphs.

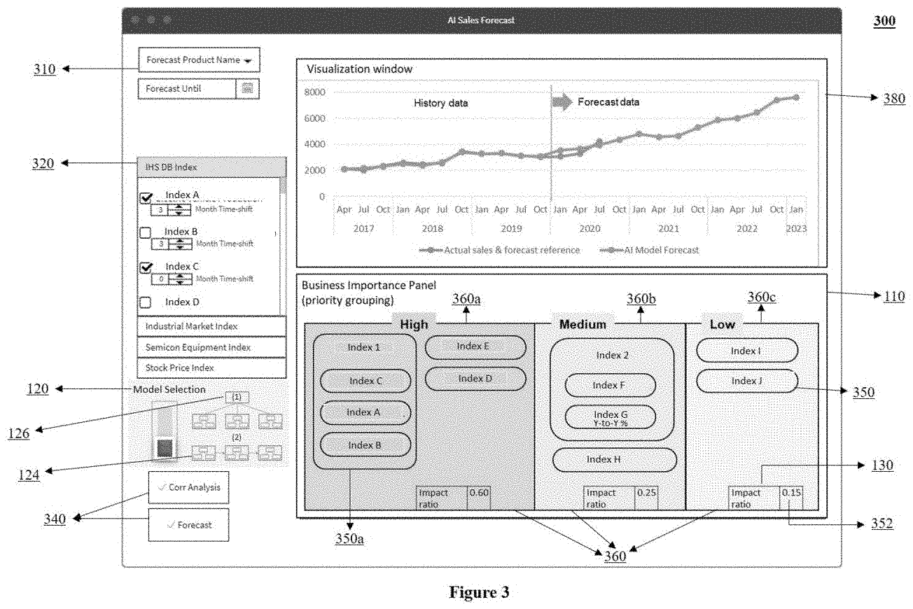

FIG. 3 illustrates the system 101 graphical user interface (GUI) featuring an overview of dashboard 300 for generating the forecast in accordance with an embodiment of the disclosure. Referring to FIG. 1, FIG. 2, and FIG. 3, the user may define a forecast criteria 310. The forecast criteria 310 such as target, granularity, forecast period, etc. is defined using the GUI providing in the dashboard 300 by the user.

Referring to FIG. 1, FIG. 2, and FIG. 3, the classifier module 110 may be configured to receive a feature 350 from the user. The classifier module 110 is configured to classify the feature 350 received from the user into a priority group 360 based on a user preference. As an example, but not limited to, the priority group 360 are defined by the user based on criteria of business importance and with numerical analysis, including a high-priority group 360a, a medium-priority group 360b, and a low-priority group 360c. The high-priority group 360a, the medium-priority group 360b, and the low-priority group 360c may be in communication with each other. As an example, the feature 350 provided by the user is created from user's business domain knowledge and similarly the priority groups 360 created by the user are also based on user defined business importance. As an example, the user may decide to place the feature 350 into one of the desired priority group 360. The user may also combine more than one feature 350 to create a group of features 350a including multiple features 350. The group of features 350a may be created by the user preference in any of the priority group 360.

In an embodiment the classifier module 110 is displayed in the GUI in FIG. 3. The user interacts with the GUI to input the feature 350 or the group of features 350a into the priority group 360. The GUI dashboard 300 may include a feature panel 320 enlisting the features 350 for the user to customize the feature 360 selection based on business domain knowledge and or with support of numerical analysis. The classifier module 110 is in communication with the impact indicator module 130.

The impact indicator module 130 may be configured to compute an impact indicator value 352. In an example, the impact indicator value 352 is being indicative of an impact strength of the corresponding priority group 360 including the feature 350 or the group of features 350a. The impact strength is often understood as influence of the feature 350 or the group of features 350a may have on the generated forecast 380. In an example, the impact indicator module 130 may compute the impact indicator value 352 based on comparing (a) the generated forecast 380 containing the feature 350 with (b) the generated forecast 380 without the at least one feature 350. Therefore, the impact indicator module 130 compares the generated forecast 380 in both (a) and (b) scenarios as mentioned above to determine effect of inclusion or exclusion of the feature 350 in the priority groups 360. In an embodiment, the GUI also displays an impact ratio 360.

The classifier module 110 may be in communication with the artificial intelligence (AI) forecast module 120. The artificial intelligence (AI) forecast module 120 may include the cascaded sub-module 124 and the hierarchical sub-module 126. As an example, the AI forecast module 120 may be configured to process the priority groups 360 containing the feature 350 provided as input by the user. In an embodiment of the invention, the AI forecast module 120 may be configured to derive a learning from classification of the feature 350 into one of the priority groups 360. The learning of the AI forecast module 120 is derived by analyzing the users input decision of classifying the feature 350 into one of the priority group 360. In an example embodiment, the GUI featuring the overview of dashboard 300 for generating the forecast 380 includes the AI forecast module 120 for user selection. The user through GUI providing the dashboard 300, selects either the cascaded sub-module 124 or the hierarchical sub-module 126 or both for generating the forecast 380.

The system GUI featuring the dashboard 300 may include an option for the user to select a type of analysis. In an example, in FIG. 3, the user may select from the analysis panel 340 either a correlation type of analysis or a forecast type of analysis.

In an example embodiment, the user provides the feature 350 as input classifying it into one of the plurality of priority group 360. The user then selects the feature 350 to be processed by the AI forecast module 120. The user also selects the type of AI forecast module 120, either the cascaded sub-module 124 or the hierarchical sub-module 126. The user also selects the forecast criteria 310 and finally selects the from the analysis panel 340 either a correlation type of analysis or a forecast type of analysis. Thus, finally, the system 101 with AI forecast module 120 processes the user inputs to generate the forecast 380. The system 101 GUI featuring the dashboard 300 may include generated forecast 380 in visual form. In an example, but not limited to, the generated forecast 380 is displayed in form of prediction line graphs plotting the forecast data predicted by the AI forecast module 120 based on user classification of the input data.

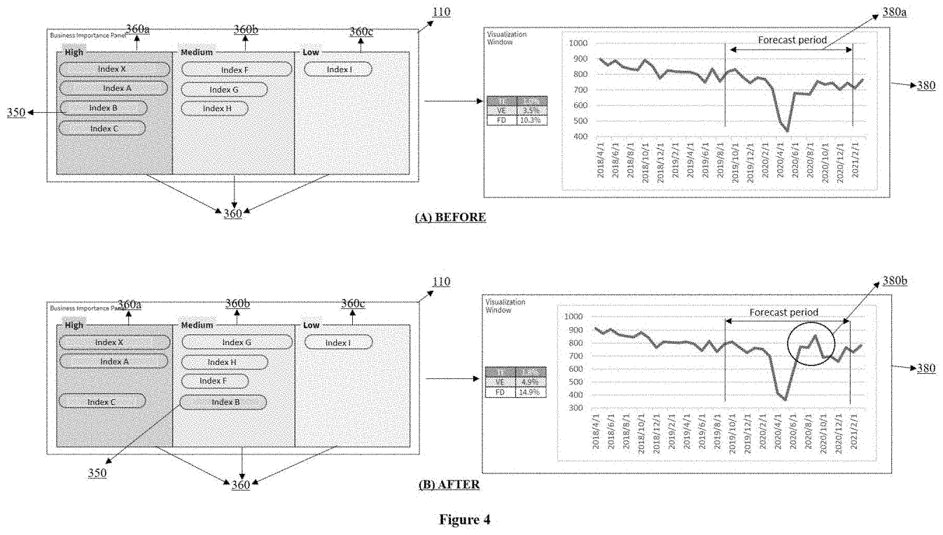

FIG. 4 illustrates an example illustration of the system 101 graphical user interface (GUI) featuring the classification of the feature 350 for generating the forecast 380, in accordance with an embodiment of the disclosure. Continuing with further description of FIG. 3, the FIG. 4 presents GUI dashboard 300 featuring the classifier module 110 with the feature 350 present in each of the priority group 360 based on the user preference. including the high priority group 360a, the medium priority group 360b and the low priority group 360c.

Further, based on the user input and selections the forecast 380 is generated in accordance with an embodiment of the disclosure. In FIG. 4, two different scenario are depicted. In the (A) Before scenario: Upon user input of the feature 350 into the priority group 360, the forecast 380 is generated. In an example, the forecast period 380a is visualized in form of graphical form.

Now in the (B) After scenario: The user edits the feature 350 from one of the priority group 360 to another priority group 360. In an example, the user provides input to the system 101 by placing the feature 350 from the high priority group 360a to the medium priority group 360b. The forecast 380 is generated. In an example, the difference in the forecast period 380b is visualized in form of graphical form.

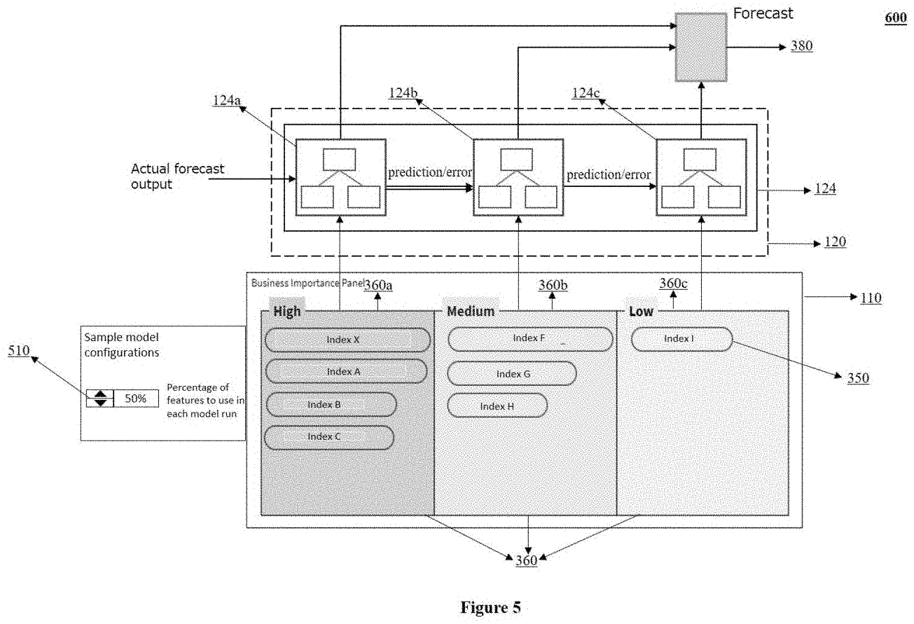

FIG. 5 illustrates a cascaded artificial intelligence model architecture 600, in accordance with an embodiment of the disclosure. Continuing with further description of FIG. 3, the artificial intelligence (AI) forecast module 120 may include the cascaded sub-module 124 and the hierarchical sub-module 126. The cascaded sub-module 124 may include, but not limited to, multiple cascaded sub-module 124. In an example, but not limited to, the cascaded sub-modules 124a, 124b and 124c are provided. In an example embodiment, the cascaded sub-modules 124a, 124b and 124c may be in communication with the classifier module 110. The cascaded sub-modules 124a, 124b and 124c may be in communication with the corresponding priority group 360 of the classifier module 110.

In an example, the cascaded sub-module 124a is in communication with the high priority group 360a, the cascaded sub-module 124b is in communication with the medium priority group 360b and the cascaded sub-module 124c is in communication with the low priority group 360c. The cascaded artificial intelligence model architecture 600 may be configured to train the separated plurality of cascaded sub-modules 124a, 124b and 124c individually.

Further, the cascaded sub-module 124a in communication with the high priority group 360a may be configured to generate the learning by receiving the feature 350 classified into the high priority group 360a and compare the learning with an actual forecast output for generating an error rate. The actual forecast output is user provided to the cascaded sub-module 124a based on the history data of business available with the user. The cascaded sub-module 124a generate the forecast 380 by deriving the learning in form of determining the business importance of the feature 350 based on which priority group 360 it is placed in. The generated forecast 380 by the cascaded sub-module 124a is compared with the actual forecast output, determining the difference between the two forecasts. Thus, the cascaded sub-module 124a may generate the error rate indicative of the deficiency in generated forecast 380 when compared with the actual forecast provided by the user. This error rate is transferred to the subsequent cascaded module 124b.

Further, the cascaded sub-module 124b receives the error rate from the cascaded sub-module 124a and may be in communication with the medium priority group 360b. The error rate received from the cascaded sub-module 124a enhances the learning of the cascaded sub-module 124b in generating more accurate forecast. The generated forecast 380 by the cascaded sub-module 124b is compared with the actual forecast output, determining the difference between the two forecasts. Thus, the cascaded sub-module 124b may generate the error rate and transfer it to the subsequent cascaded module 124c.

Similarly, the cascaded sub-module 124c receives the error rate from the cascaded sub-module 124b and may be in communication with the low priority group 360c. The error rate received from the cascaded sub-module 124b enhances the learning of the cascaded sub-module 124c in generating more accurate forecast 380.

In an embodiment, the cascaded sub-modules 124a, 124b and 124c are trained separately after receiving the feature 350 from the corresponding priority group 360. The learning generates the error rate which is then received by the subsequent sub-module for enhanced learning.

In an embodiment, the user provides input to the classifier module 110 as a parameter information indicative of an optimization variable 510. The optimization variable 510, is indicative of a percentage of the feature 350 to be received by each of the plurality of cascaded sub-modules 124 and number of iterations each of the cascaded sub-modules 124 may be operating for enhanced learning. In an example, the user provides the optimization variable 510 through GUI dashboard.

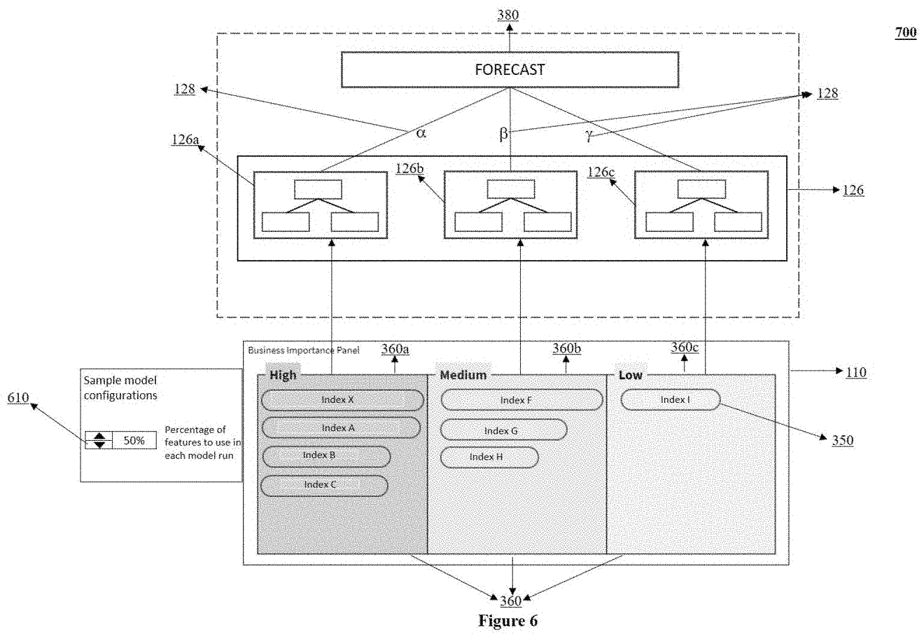

FIG. 6 illustrates a hierarchical architecture intelligence model architecture 700, according to an embodiment of the present disclosure. Continuing with further description of FIG. 3, the artificial intelligence (AI) forecast module 120 may include the cascaded sub-module 124 and the hierarchical sub-module 126. In an example, the hierarchical sub-module 126 may include but not limited to, multiple hierarchical sub-modules 126a, 126b, 126c. In an example embodiment, the hierarchical sub-modules 126a, 126b, 126c may be in communication with the classifier module 110. The hierarchical sub-modules 126a, 126b, 126c may be in communication with the corresponding priority group 360 of the classifier module 110.

In an example, the hierarchical sub-module 126a is in communication with the high priority group 360a, the hierarchical sub-module 126b is in communication with the medium priority group 360b and the hierarchical sub-module 126c is in communication with the low priority group 360c. The hierarchical artificial intelligence model architecture 700 may be configured to train the separated plurality of hierarchical sub-modules 126a, 126b and 126c individually.

Further, the hierarchical sub-module 124a in communication with the high priority group 360a may be configured to generate the learning by receiving the feature 350 classified into the high priority group 360a. The hierarchical sub-module 124a generate the forecast 380 by deriving the learning in form of determining the business importance of the feature 350 based on which priority group 360 it is placed in.

The hierarchical sub-module 124b in communication with the medium priority group 360b may be configured to generate the learning by receiving the feature 350 classified into the medium priority group 360b. The hierarchical sub-module 124b generate the forecast 380 by deriving the learning in form of determining the business importance of the feature 350 based on which priority group 360 it is placed in.

Similarly, the hierarchical sub-module 124c in communication with the low priority group 360c may be configured to generate the learning by receiving the feature 350 classified into the low priority group 360c. The hierarchical sub-module 124c generate the forecast 380 by deriving the learning in form of determining the business importance of the feature 350 based on which priority group 360 it is placed in.

In an embodiment, the user provides input to the classifier module 110 as a parameter information indicative of the optimization variable 610. The optimization variable 610, is indicative of the percentage of the feature 350 to be received by each of the plurality of hierarchical sub-modules 126 and number of iterations each of the hierarchical sub-modules 126 may be operating for enhanced learning. In an example, the user provides the optimization variable 610 through GUI dashboard.

In an embodiment, the user provides input to the AI forecast module 120 as a ratio 128 indicative of an impact strength of each of the plurality of hierarchical sub-modules 126 on the forecasting influencing the generated forecast. In an example embodiment, the ratio 128 is for each of the hierarchical sub-modules 126. The ratio 128 may be configured to determine the influence of the corresponding hierarchical sub-modules 126 on the generated forecast 380. In an example, α is the ratio 128 for the hierarchical sub-modules 126a, β is the ratio 128 for the hierarchical sub-modules 126b and γ is the ratio 128 for the hierarchical sub-modules 126c.

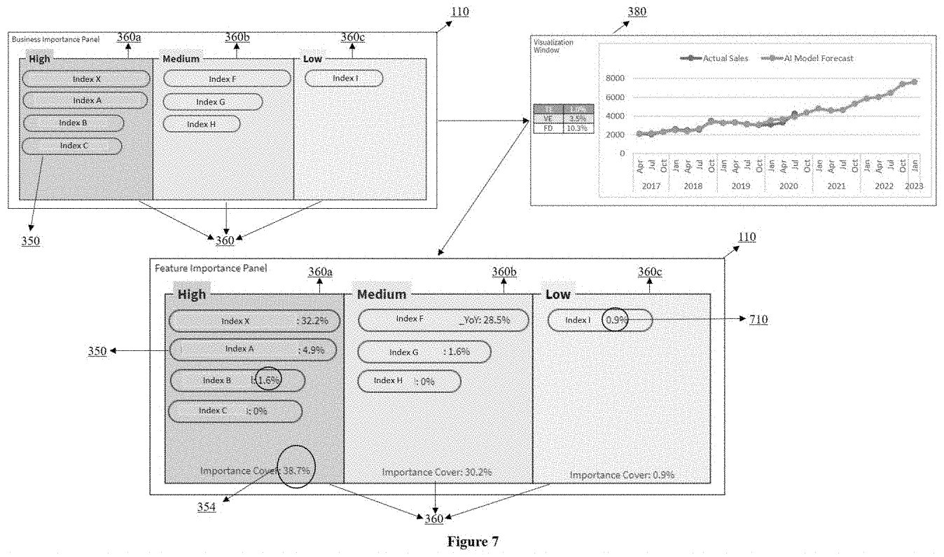

FIG. 7 illustrates an example illustration of the system graphical user interface (GUI) featuring the impact indicator value 710, according to an embodiment of the present disclosure.

The impact indicator module 130 may be configured to compute an impact indicator value 710 corresponding to the feature 350 classified into the priority group 360. The impact indicator value 710 is being indicative of an impact strength i.e., influence of the feature 350 classified into the plurality of priority group 360, on the generated forecast 380. In an example, the impact indicator value 710 is computed based on comparing (a) the generated forecast 380 with the feature 350 and (b) the generated forecast 380 without the feature 350.

In an embodiment, the impact indicator value 710 is displayed on the GUI dashboard along with the corresponding feature 350 in the priority group 360.

Further, the impact indicator module 130 may be configured to compute an importance cover value 354 corresponding to each of the priority group 360. The importance cover value 354 is being indicative of a value representing the effectiveness of the priority group 360 on the generated forecast 380.

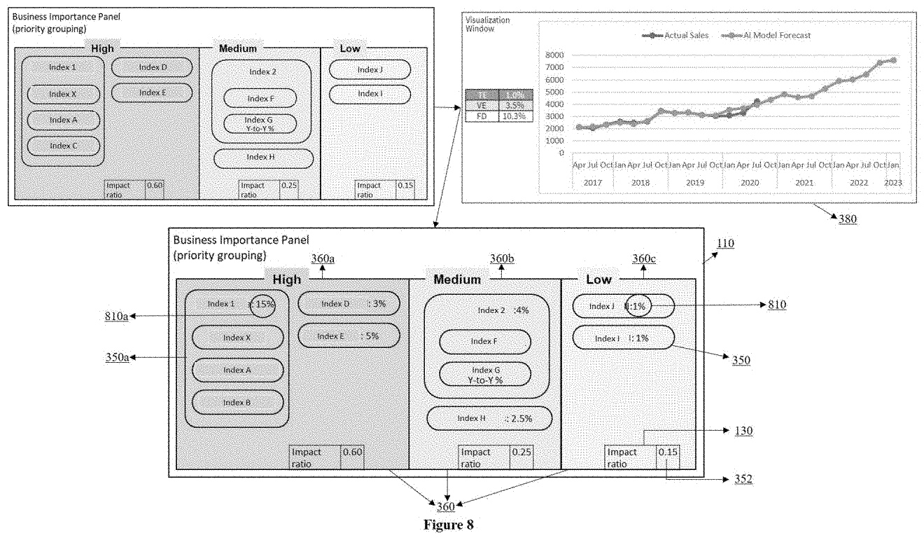

FIG. 8 illustrates an example illustration of the system graphical user interface (GUI) featuring the impact indicator value 810, according to an embodiment of the present disclosure.

The impact indicator module 130 may be configured to compute an impact indicator value 810, 810a corresponding to the feature 350 and the group of features 350a classified into the priority group 360. The impact indicator value 810, 810a is being indicative of the impact strength i.e., influence of the feature 350 and the group of features 350a classified into the plurality of priority group 360, on the generated forecast 380. In an example, the impact indicator value 810, 810a is computed based on comparing (a) the generated forecast 380 with the feature 350 or the group of features 350a and (b) the generated forecast 380 without the feature 350 or without the group of features 350a.

In an embodiment, the impact indicator module 130 may be configured to compute the impact indicator value 352. In an example, the impact indicator value 352 is being indicative of an impact strength of the corresponding priority group 360 including the feature 350 or the group of features 350a. The impact strength is often understood as influence the feature 350 or the group of features 350a may have on the generated forecast 380.

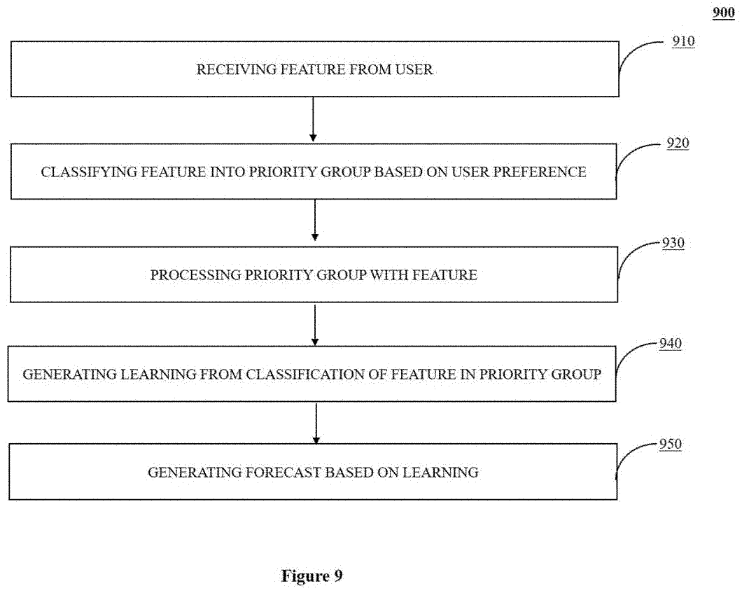

FIG. 9 illustrates a flowchart of the method 900 for generating forecast, according to an embodiment of the present disclosure. The method 900 may be a computer-implemented method executed. For the sake of brevity, constructional and operational features of the system 101 that are already explained in the description of FIG. 1, FIGS. 2 and 3 are not explained in detail in the description of FIG. 9.

At step 910, an alternative embodiment of the present invention, the method 900 includes receiving a feature from a user.

In continuity with the previous step, at step 920, the feature is classified into a priority group based on a user preference. The user classifies the feature into the priority group manually based on business domain knowledge.

In an embodiment, the method 900 includes classifying, by a classifier module, the feature into the priority groups based on the user preference, and the priority groups are defined by the user based on criteria of business importance and with numerical analysis, including a high-priority group, a medium-priority group, and a low-priority group. The feature provided as input by the user can be a single feature or a group of features.

At step 930, the method includes processing the plurality of priority groups with the feature. The processing includes receiving the features corresponding to the priority group by an artificial intelligence forecast module.

In continuity with the previous step, at step 940, the method 900 includes generating, a learning when the feature corresponding to the priority group is processed. The learning represents the business importance of the feature according to the priority group it is placed in.

At step 950, the method 900 includes generating the forecast based on the learning.

In an advantage of the present subject matter, the user classifies the feature into the priority groups based on criteria of business importance and or with numerical analysis. The AI forecast module 120 takes advantage of business importance information provided in form of user classifying the feature 350 in the certain priority group 360 to improve forecast accuracy. The impact of the feature 350 classification in the certain priority group 360 impacts the before/after forecast results as seen in one of the figures of the embodiment. The user-based classification of the feature 350 increases business explanatory power, forecast accuracy and robustness of the system 101.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms or both terms. For example, the phrase “A or B” should be understood to include the possibilities of “A” or “B” or “A and B.”

All examples and conditional language recited in this disclosure are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that various changes, substitutions, and alterations could be made thereto without departing from the spirit and scope of the present disclosure.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A system for generating a forecast comprising:
a classifier module configured to receive from a user, at least one feature and further configured to:
classify the at least one feature into a plurality of priority groups based on a user preference;
an artificial intelligence (AI) forecast module in communication with the classifier module configured to:
process the plurality of priority groups with at least one feature for deriving a learning from classification of the at least one feature into the plurality of priority groups; and
generate the forecast based on the learning.

2. The system as claimed in claim 1, wherein the classifier module is configured to classify the at least one feature into the plurality of priority groups based on the user preference, wherein the plurality of priority groups defined by the user based on criteria of business importance and with numerical analysis, comprising a high-priority group, a medium-priority group, and a low-priority group.

3. The system as claimed in claim 2, wherein the user provides the at least one feature as an individual or in a group of feature to each of the high-priority group, the medium-priority group, and the low-priority group.

4. The system as claimed in claim 3, further in the AI forecast module comprising:
a plurality of cascaded sub-modules corresponding to each of the plurality of priority groups;
wherein the plurality of cascaded sub-modules is configured to:
generate the learning by receiving the at least one feature classified into the corresponding priority group and compare the learning with an actual forecast output for generating an error rate; wherein the error rate is received by the subsequent cascaded sub-module for enhanced learning;
generate the forecast based on the learning.

5. The system as claimed in claim 4, wherein the classifier module receives a user input indicative of a selection of a percentage and/or number of the at least one feature in each of the priority group to be provided to the AI forecast module.

6. The system as claimed in claim 4, wherein each of the plurality of cascaded sub-modules receives a parameter information from the user; indicative of:
an optimization variable, a percentage of the at least one feature to be received by each of the plurality of cascaded sub-modules and number of iterations for learning.

7. The system as claimed in claim 3, wherein the AI forecast module comprising:
a plurality of hierarchical sub-modules corresponding to each of the plurality of priority groups;
wherein the plurality of hierarchical sub-modules is configured to:
generate the learning by receiving the at least one feature classified into the corresponding priority group and generate the forecast based on the learning.

8. The system as claimed in claim 7, wherein the classifier module receives a user input indicative of a selection of a percentage and/or number of the at least one feature in each of the priority group to be provided to the AI forecast module.

9. The system as claimed in claim 7, wherein the AI forecast module receives from the user a ratio indicative of an impact strength of each of the plurality of hierarchical sub-modules on the generated forecast.

10. The system as claimed in claim 7, wherein each of the plurality of hierarchical sub-modules receives the parameter information from the user; indicative of:
an optimization variable, the percentage of feature to be received by each of the plurality of hierarchical sub-modules and number of iterations for learning.

11. The system as claimed in claim 1, further in comprises an impact indicator module configured to: compute an impact indicator value corresponding to the at least one feature classified into the plurality of priority group;
wherein the impact indicator value being indicative of an impact strength of the corresponding at least one feature classified into the plurality of priority group, on the generated forecast;
the impact indicator value is computed based on comparing the generated forecast with the at least one feature and the generated forecast without the at least one feature.

12. The system as claimed in claim 11, wherein the impact indicator module is configured to compute the impact indicator value corresponding to the group of features classified into the plurality of priority group, wherein the impact indicator value being indicative of an impact strength of the corresponding group of features classified into the plurality of priority group; and
further configured to compute the impact indicator value corresponding to each of the priority group, wherein the impact indicator value being indicative of an impact strength of the corresponding plurality of priority group.

13. A method for generating a forecast comprising:
receiving, by a classifier module, at least one feature from a user;
classifying, by the classifier module, the at least one feature into a plurality of priority groups based on a user preference;
processing, by an artificial intelligence (AI) forecast module, the plurality of priority groups with at least one feature;
deriving, by the artificial intelligence (AI) forecast module, a learning from classification of the at least one feature into the plurality of priority groups; and
generating the forecast based on the learning.

14. The method as claimed in claim 13, wherein
classifying, by the classifier module, the at least one feature into the plurality of priority groups based on the user preference, wherein the plurality of priority groups defined by the user based on criteria of business importance and with numerical analysis, comprising a high-priority group, a medium-priority group, and a low-priority group.

15. The method as claimed in claim 14, wherein the user provides the at least one feature as an individual or in a group to each of the high-priority group, the medium-priority group, and the low-priority group.

16. The method as claimed in claim 15, further in the AI forecast module comprising:
generating, by a plurality of cascaded sub-modules, the learning by receiving the at least one feature classified into the corresponding priority group;
comparing the learning with an actual forecast output for generating an error rate; wherein the error rate is received by the subsequent sub-module for enhanced learning;
generating the forecast based on the learning.

17. The method as claimed in claim 16, wherein
receiving, by the classifier module, a user input indicative of a selection of a percentage and/or number of the at least one feature in each of the priority group to be provided to the AI forecast module.

18. The method as claimed in claim 16, wherein,
receiving, by each of the plurality of cascaded sub-modules, a parameter information from the user indicative of:
an optimization variable, a percentage of feature to be received by each of the plurality of cascaded sub-modules and number of iterations for learning.

19. The method as claimed in claim 15, wherein the AI forecast module comprising:
generating, by a plurality of hierarchical sub-modules corresponding to each of the plurality of priority groups, the learning by receiving the at least one feature classified into the corresponding priority group and
generating the forecast based on the learning.

20. The method as claimed in claim 19, wherein the classifier module comprising:
receiving a user input indicative of a selection of a percentage and/or number of the at least one feature in each of the priority group to be provided to the AI forecast module.

21. The method as claimed in claim 19, wherein the AI forecast module comprising:
receiving from the user a ratio indicative of an impact strength of each of the plurality of hierarchical sub-modules on the generated forecast.

22. The method as claimed in claim 19, wherein each of the plurality of hierarchical sub-modules comprising:
receiving the parameter information from the user; indicative of:
the optimization variable, the percentage of feature to be received by each of the plurality of hierarchical sub-modules and number of iterations for learning.

23. The method as claimed in claim 13, further in comprises
computing, by an impact indicator module, an impact indicator value corresponding to the at least one feature classified into the plurality of priority group;
wherein the impact indicator value being indicative of an impact strength of the corresponding at least one feature classified into the plurality of priority group, on the generated forecast; the impact indicator value is computed based on comparing the generated forecast with the at least one feature and the generated forecast without the at least one feature.

24. The method as claimed in claim 23, wherein the impact indicator module comprising:
computing the impact indicator value corresponding to the group of features classified into the plurality of priority group wherein the impact indicator value being indicative of an impact strength of the corresponding group of features classified into the plurality of priority group; and
computing the impact indicator value corresponding to each of the priority group, wherein the impact indicator value being indicative of an impact strength of the corresponding priority group.
